(19) United States
(12) Patent Application Publication
(10) Pub. No.: US 2010/0045683 A1
(43) Pub. Date: Feb. 25, 2010

(54) HARDWARE TYPE VECTOR GRAPHICS ACCELERATOR

(76) Inventors: YOUNG OUK KIM, Gyeonggi-Do (KR); HYUN JAE WOO, Gyeonggi-Do (KR); CHAY HYUN KIM, Seoul (KR)

Correspondence Address: FISH & RICHARDSON, PC, P.O. BOX 1022, MINNEAPOLIS, MN, 55440-1022, US

(21) Appl. No.: 12/427,658

(22) Filed: Apr. 21, 2009

(30) Foreign Application Priority Data
Apr. 21, 2008 (KR) 10-2008-0036746

(51) Int. Cl. G06T 1/20; G09G 5/36

(52) U.S. Cl. 345/506; 345/545

(57) ABSTRACT

Techniques, apparatus and system are described for providing a hardware-type vector graphics acceleration. In one aspect, a hardware-type vector graphics accelerator includes graphics processing modules to communicate with a controller unit. The graphics processing modules include at least one of a rasterizing setup module, a scissor module, a paint generation module, an alpha masking module, and a blending module connected together according to a pipeline architecture to perform two-dimensional (2D) vector graphics acceleration in response to one or more commands received from the controller unit.

### CROSS-REFERENCE TO RELATED PATENT APPLICATION

This application claims the benefit of Korean Patent Application No. 10-2008-0036746, filed on Apr. 21, 2008, in the Korean Intellectual Property Office, the disclosure of which is incorporated herein in its entirety by reference.

### BACKGROUND

The present disclosure relates to an application processor of a mobile communication terminal.

Vector graphics are digital images of an object that are created by placing lines or shapes in a given two-dimensional (2D) or three-dimensionally (3D) space by using a sequence of commands or mathematical representations. In terms of physics, a vector is a mathematical object that has a size, called magnitude, and direction. However, in terms of vector graphics, a vector describes a method of forming graphics corresponding to a bitmap. That is, in the field of vector graphics, graphic files that are the result of users' creative activities are created and stored in the format of a sequence of vector statements.

For example, in order to draw a line, information regarding the locations of a sequence of dots that are to be connected is stored in a vector graphics file instead of bits of the line. Thus, the size of the vector graphics file is less than that of a bitmap graphics file or a raster image file. Also, the vector graphics file is easier to correct than a raster image file.

Vector graphics include scalable vector graphics (SVG), such as an extensible markup language (XML) application, for performing graphics processing on an image. SVG is XML-based graphics standards suggested by the World Wide Web Consortium (W3C). SVG enjoys all the advantages of XML, such as openness and interoperability. Also, SVG can be applied to various web applications because SVG can be combined with other types of XML, such as synchronized multimedia integration language (SMIL), geography markup language (GML), and mathematical markup language (MathML). Further, SVG allows high-quality dynamic graphics to be created from real-time data.

### SUMMARY

In one aspect, a hardware-type vector graphics accelerator includes graphics processing modules to communicate with a controller unit. The graphics processing modules include at least one of a rasterizing setup module, a scissor module, a paint generation module, an alpha masking module, and a blending module connected together according to a pipeline architecture to perform two-dimensional (2D) vector graphics acceleration in response to one or more commands received from the controller unit.

Implementations can optionally include one or more of the following features. The controller unit can include a command core and parser unit to process and parse vector graphics data and the one or more commands used to instruct the graphics processing modules to perform the 2D vector graphics acceleration. The command core and parser unit can be configured to communicate with a register set that includes multiple registers to store the one or more commands. The controller unit can include a cache memory that includes dedicated caches. Each dedicated cache can communicate with a corresponding one of the paint generation module, the alpha masking module, and the blending module respectively. The controller unit can include a cache controller to communicate with the cache memory to control each dedicated cache in response to one or more commands from a cache core. The cache core can communicate with the cache controller to process the one or more commands to instruct the cache controller to control the caches. The controller unit can include a buffer controller to communicate with the cache core to control a pixel buffer in response to at least another command received from the cache core. The pixel buffer can communicate with the buffer controller to store final pixel data under the control of the buffer controller. The graphics processing modules can be configured to process contents based on open vector graphics accelerator (OpenVG) application programming interface (API) standards of Khronos group. The accelerator can include an application programming interface (API) adapted to be compliant with an OpenVG pipeline architecture, and the accelerator can be interfaced with a duration of graphics accelerating of the open vector graphics accelerator (OpenVG).

In another aspect, a vector graphic acceleration application processor includes a register set that includes multiple registers to store one or more commands adapted for vector graphics acceleration of vector graphics data. The vector graphics acceleration application processor includes a controller unit to communicate with the register set. The controller unit includes at least a command core and parser unit to process and parse the one or more stored commands and the vector graphics data. The vector graphics acceleration application processor includes a hardware-type vector graphics accelerator to communicate with the controller unit to process vector graphics acceleration on the vector graphics data in a hardware manner in response to receiving at least one of the parsed and processed commands from the command core and parser unit.

Implementations can optionally include one or more of the following features. The hardware-type vector graphics accelerator can include graphics processing modules that include at least one of a rasterizing setup module, a scissor module, a paint generation module, an alpha masking module, and a blending module connected together according to a pipeline architecture. The graphics processing modules can be configured to operate in response to the received at least one parsed and processed command from the command core and parser unit. The vector graphic acceleration application processor can include a cache memory that includes dedicated caches, each dedicated cache to communicate with a corresponding one of the paint generation module, the alpha masking module, and the blending module respectively. The vector graphic acceleration application processor can include a cache controller to communicate with the cache memory to control each dedicated cache in response to one or more commands from a cache core. The cache core can communicate with the cache controller to process the one or more commands to instruct the cache controller to control the caches. The vector graphic acceleration application processor can include a buffer controller to communicate with the cache core to control a pixel buffer in response to at least another command received from the cache core. The pixel buffer can communicate with the buffer controller to store final pixel data under the control of the buffer controller. The command core and parser unit and the cache core can be connected to an arm core using an advanced high-performance bus (AHB) slave and an AHS master respectively. To process the vector graphics data, the vector graphics accelerator can include a path generation module to generate path segment commands according to each of processing units in the paint generation module, based on values stored in the register set. The path segment commands an include commands for straight lines, commands for Bezier curves, and commands for elliptical arcs. The path generation module can be configured to sort reconstructed straight lines based on a merge sorting algorithm to apply the reconstructed straight lines to a filling rule. The processing units in the paint generation module can include a solid unit for solid color processing, an image unit, a pattern unit, a linear gradient unit, and a radial gradient unit. Also, the blending module can include mode units that include a blend mode unit and a blend image mode unit for blending processing. The processing units of the paint generation module and the mode units of the blending module respectively perform the color processing and the blending processing by using a color processing method and a blending processing method, based on open vector accelerator (OpenVG) application programming interface (API) standards of Khronos group.

In another aspect, a vector accelerating method includes detecting a state of a vector graphics acceleration application processor. When detecting that the vector graphics acceleration application processor is in an idle state, initializing a hardware-type vector graphics accelerator of the vector graphics acceleration application processor. Also, the method includes controlling the initialized hardware-type vector graphics accelerator to accelerate vector graphics data, and closing the vector graphics accelerator.

Implementations can optionally include one or more of the following features. Accelerating the vector graphics data can include checking caches used in the vector graphics accelerating to determine whether to reprocess a command that has already been processed. Also, accelerating the vector graphics data can include scissoring the vector graphics data to scissor-out undesired graphics elements, and rendering the scissored vector graphics data to perform color processing. Detecting the state of the vector graphics acceleration application processor, scissoring, and closing of the vector graphics accelerator can be performed according to a loop-back scheme and based on a register value of each frame of the vector graphics data. The method can also include clearing a frame buffer after detecting the state of the vector graphics acceleration application processor. Accelerating of the vector graphics data can be performed by the initialized hardware-type vector graphics accelerator in response to one or more commands from a command core and parser unit included in the vector graphics acceleration application processor. Accelerating of the vector graphics data can be performed by a rasterizing setup module, a scissor module, a paint generation module, an alpha masking module, and a blending module which are connected to the command core and parser unit, wherein the rasterizing setup module, the scissor module, the paint generation module, the alpha masking module, and the blending module are connected together according to a pipeline architecture in the vector graphics accelerator. The paint generation module, the alpha masking module, and the blending module can be respectively connected to corresponding caches. Also, the method can include processing and parsing, at the command core and parser unit, the vector graphics data and the one or more commands adapted to perform the vector graphics acceleration. The method can include storing final pixel data in a pixel buffer. The method can include processing, at the cache core, commands for operating the caches and the pixel buffer; and controlling, at a cache controller and a buffer controller, the caches and the pixel buffer respectively in response to the commands from the cache core. Controlling the initialized hardware-type vector graphics accelerator to accelerate the vector graphics data can include generating, at a path generation module, path segment commands according to each processing unit in the paint generation module, based on values stored in a register set that stores the one or more commands adapted for vector graphics acceleration; and sorting reconstructed straight lines based on a merge sorting algorithm to apply the reconstructed straight lines to a filling rule. Color processing can be performed by a solid unit, an image unit, a pattern unit, a linear gradient unit, and a radial gradient unit which are included in the paint generation module. Also, blending processing can be performed using a blend mode unit and a blend image mode unit included in the blending module. Further, the method can include performing color processing and blending processing, at the processing units of the paint generation module and the mode units of the blending module respectively, by using a color processing method and a blending processing method based on open vector accelerator (OpenVG) application programming interface (API) standards of Khronos group. Accordingly, the hardware type vector graphics accelerator connected to the command core and parser is used prior to accelerating the graphics, thereby allowing the vector graphics to be processed at high speeds.

The techniques, apparatus and systems as described in this specification can optionally provide one or more of the following advantages. Hardware implementation of vector graphics accelerator provides faster processing speed compared to conventional software only rendering. The increase in processing speed makes the hardware vector graphics accelerator ideal for mobile environments.

### BRIEF DESCRIPTION OF THE DRAWINGS

FIG. 1A is a schematic block diagram of a vector graphics acceleration application processor according to an embodiment of the present disclosure;

FIG. 1B is a schematic block diagram of a vector graphics acceleration application processor according to another embodiment of the present disclosure;

FIG. 2 is a block diagram illustrating in detail the vector graphics acceleration application processor of FIG. 1A;

FIG. 3 is a block diagram illustrating in detail modules of FIG. 2 that generate two-dimensional (2D) vector elements; and

FIG. 4 is a flowchart illustrating a vector graphics accelerating method according to an embodiment of the present disclosure.

The same reference numerals represent the same elements throughout the drawings.

### DETAILED DESCRIPTION

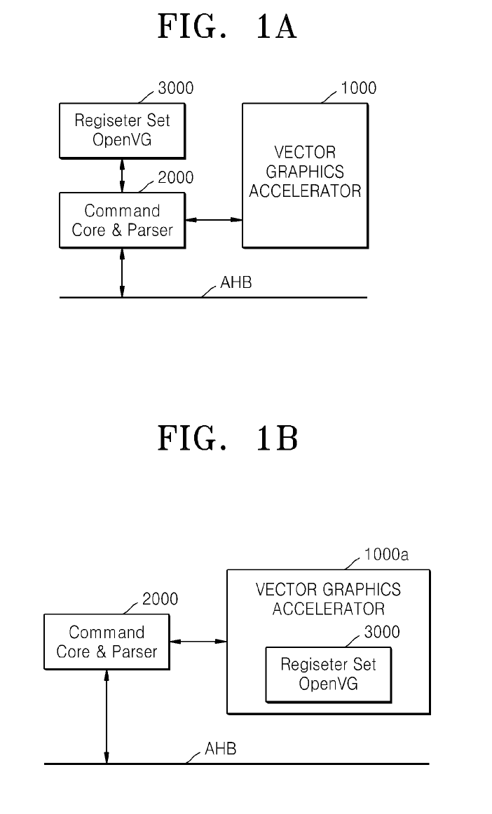

FIG. 1A is a schematic block diagram of a vector graphics acceleration application processor according to an embodiment of the present disclosure. Referring to FIG. 1A, the vector graphics acceleration application processor includes a command core and parser 2000 that processes commands and vector graphics data for vector graphics acceleration, a register set open vector graphics accelerator (OpenVG) unit 3000 that stores the commands for vector graphics acceleration, and a hardware-type vector graphics accelerator 1000 that processes the vector graphics acceleration of the vector graphics data in a hardware manner, in response to a command from the command core and parser 2000. The command core and parser 2000 is connected to an arm core using an advanced high-performance bus (AHB) slave to receive commands and data for graphics acceleration from the arm core. Also, the vector graphics accelerator 1000 can include one or more graphics processing modules to process the vector graphics data and generate related output graphics data.

The command core and parser 2000 processes and parses commands that are set in the register set OpenVG unit 3000 and thus includes a command core for processing the commands and a command parser for parsing the commands. The command core and parser 2000 directly controls each module included in the vector graphics accelerator 1000 in a hardware manner and by using the commands stored in the register set OpenVG unit 3000. Thus, the vector graphics accelerator 1000 is capable of processing the vector graphics data at far faster speeds than when conventionally run in a software manner that does not use specific hardware components.

The register set OpenVG unit 3000 includes multiple registers to store commands for setting OpenVG parameters, such as a ‘scissor’ parameter, a ‘rectangles’ parameter, a ‘paint type’ parameter, an ‘alpha masking flag’ parameter, and a ‘blend mode’ parameter. The commands stored in the register set OpenVG unit 3000 are base values that are set by a software driver, and allow use of contents according to the OpenVG application programming interface (API) standards of the Khronos group.

The vector graphics accelerator 1000 is directly controlled by the command core and parser 2000 as described above to cause the graphics processing modules in the vector graphics accelerator 1000 to process the vector graphics data in a hardware manner. The vector graphics accelerator 1000 can be referred to as a rendering engine or a raster engine but will be hereinafter referred to as a ‘vector graphics accelerator’ because the vector graphics accelerator includes all modules for processing graphics.

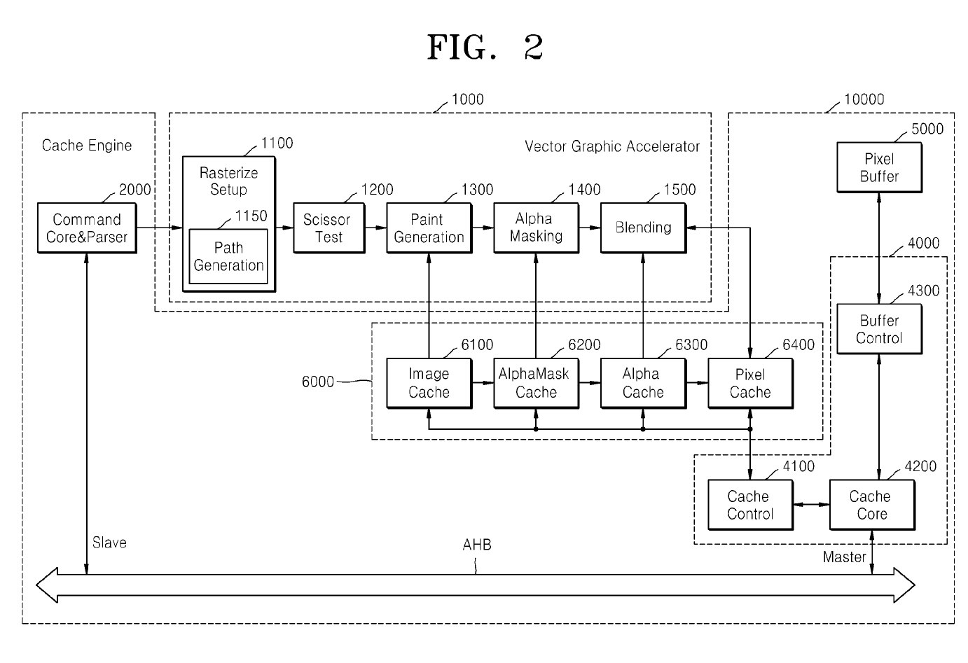

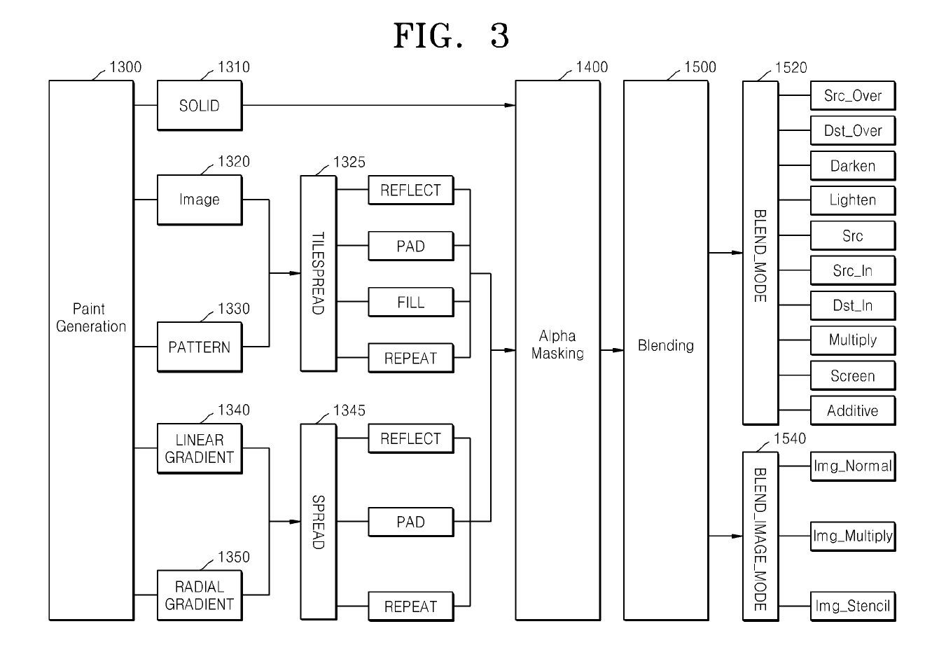

As described above, the command core and parser 2000 is connected to an arm core via an advanced high-performance bus (AHB) slave to receive commands and data from the arm core. The vector graphics accelerator 1000 is described further with reference to FIGS. 2 and 3 below.

FIG. 1B is a schematic block diagram of a vector graphics acceleration application processor according to another embodiment of the present disclosure. Referring to FIG. 1B, the vector graphics acceleration application processor is the same as the application processor of FIG. 1A except that a register set OpenVG unit 3000 is included in the vector graphics accelerator 1000a. The register set OpenVG unit 3000 may be located on various locations on the application processor as long as the register set OpenVG unit 3000 can be connected to a command core and parser 2000 and modules included in the vector graphics accelerator 1000a.

FIG. 2 is a block diagram illustrating in detail the vector graphics acceleration application processor of FIG. 1A. Referring to FIG. 2, the vector graphics acceleration application processor includes the vector graphics accelerator 1000, and a controller 10000 which can be represented as a cache engine. The controller 10000 includes the command core and parser 2000, a register set (not shown), a pixel buffer 5000, a cache memory 6000, and a cache and buffer controller unit 4000 for controlling the cache memory 6000 and the pixel buffer 5000.

The vector graphics accelerator 1000 includes graphics processing modules including a rasterizing setup module 1100, a scissor module 1200, a paint generation module 1300, an alpha masking module 1400, and a blending module 1500. These graphics processing modules can generate related graphics data.

In the vector graphics accelerator 1000, the modules are connected according to a pipeline architecture to process graphics. Each of the modules generates related graphics data, and final pixel data output generated using the blending module 1500 is temporarily stored in a pixel cache 6400. Also, the final pixel data is finally stored in the pixel buffer 5000 or a frame buffer (not shown) to be displayed on a screen of a display unit.

The rasterizing setup module 1100 sets up base coordinates for graphics of an object, which is to be graphically processed, and the scissor module 1200 checks and scissors unnecessary parts of the graphics. The paint generation module 1300 assigns color values corresponding to frame buffer coordinates according to paint type. The alpha masking module 1400 performs alpha masking in order to obtain projective effects. The blending module 1500 generates data regarding a combination of two graphics, e.g., data regarding the effect of mixing colors. In general, graphics processing performed by the paint generation module 1300, the alpha masking module 1400, and the blending module 1500 that actually perform graphics processing, is referred to as rendering processing.

The rasterizing setup module 1100 includes a path generation module 1150. According to the OpenVG standards, path segment commands are largely classified into commands for straight lines, commands for Bezier curves, and commands for elliptical arcs. Bezier curves and elliptical arcs of the path segment commands are reconstructed to be straight lines, and the straight lines are sorted by the path generation module 1150 in order to apply a filling rule thereto. In the current embodiment, straight lines are sorted using a merge sorting method from among various sorting algorithms, thereby reducing the frequency of memory access and minimizing cache size.

The cache memory 6000 includes various cache units including an image cache 6100 used by the paint generation module 1300, an alpha mask cache 6200 used by the alpha masking module 1400, an alpha cache 6300 used by the blending module 1500, and a pixel cache 6400 storing final pixel data generated by the blending module 1500. The image cache 6100, the alpha mask cache 6200, and the alpha cache 6300 provide cache data for graphics processing to corresponding modules of the vector graphics accelerator 1000. That is, data read from or written to the cache memory 6000 is output from or input to the cache memory 6000.

The cache and buffer controller unit 4000 includes a cache controller 4100 that controls the caches of the cache memory 6000, a cache core 4200 that delivers control commands to the cache controller 4100 and a buffer controller 4300, and the buffer controller 4300 that controls the pixel buffer 5000. That is, the cache and buffer controller unit 4000 controls the caches of the cache memory 6000 and the pixel buffer 5000.

As illustrated in FIG. 2, the command core and parser 2000 and the cache core 4200 are respectively connected to an arm core (not shown) via an AHB slave and an AHB master to receive commands and data for graphics acceleration from the arm core.

FIG. 3 is a block diagram illustrating in detail the modules of FIG. 2 that generate two-dimensional (2D) vector elements. That is, FIG. 3 illustrates in more detail the paint generation module 1300, the alpha masking module 1400 and the blending module 1500 of FIG. 2.

Referring to FIG. 3, the paint generation module 1300 assigns color values corresponding to frame buffer coordinates according to paint type. The paint generation module 1300 includes a solid unit 1310 for performing solid color processing, an image unit 1320, a pattern unit 1330, a linear gradient unit 1340 for performing gradient processing on straight lines, and a radial gradient unit 1350 for performing gradient processing on curves.

The solid unit 1310 gives a single color to an object. The linear gradient unit 1340 calculates the relationship between a line connecting two points (x0, y0) and (x1, y1) of a given parameter and frame buffer coordinates, and maps the calculating result to 256 color ramp values. The radial gradient unit 1350 maps a central point (cx, cy), a focused point (fx, fy), and the radius r of a circle to the color ramp values. The image unit 1320 and the pattern unit 1330 obtain colors corresponding to the frame buffer coordinates by performing interpolation on a given image.

A tilespread unit 1325 and a spread unit 1345 respectively perform tile processing and spread processing according to the above color vector elements obtained by the above modules of the paint generation module 1300. The tile processing includes reflecting, padding, filling, and repetitive processing, and the spread processing includes reflecting, padding, and repetitive processing.

Then, the alpha masking unit 1400 checks a register mask flag and performs masking by using an alpha value read from the alpha mask cache 6200.

The blending module 1500 performs final pixel blending in the vector graphics accelerator 1000. For example, the vector graphics accelerator 1000 includes a blend mode (BLEND_MODE) 1520 and a blend image mode (BLEND_IMAGE_MODE) 1540 that are categorized according to paint type. In these modes, blending may be performed in various ways as illustrated in FIG. 3.

The functions of the above described modules have been specified in the OpenVG API standards. Thus, a detailed description of a technique of color processing or blending as found in the OpenVG API standards is incorporated in this specification by reference.

As illustrated in FIG. 2 or 3, a vector graphics acceleration application processor according to an embodiment of the present disclosure is designed to use various contents according to the OpenVG API standards. That is, a vector graphics accelerator included in this application processor is designed to have an API according to the OpenVG pipeline architecture of the Khronos group, and to be interfaced with graphic accelerating of the OpenVG.

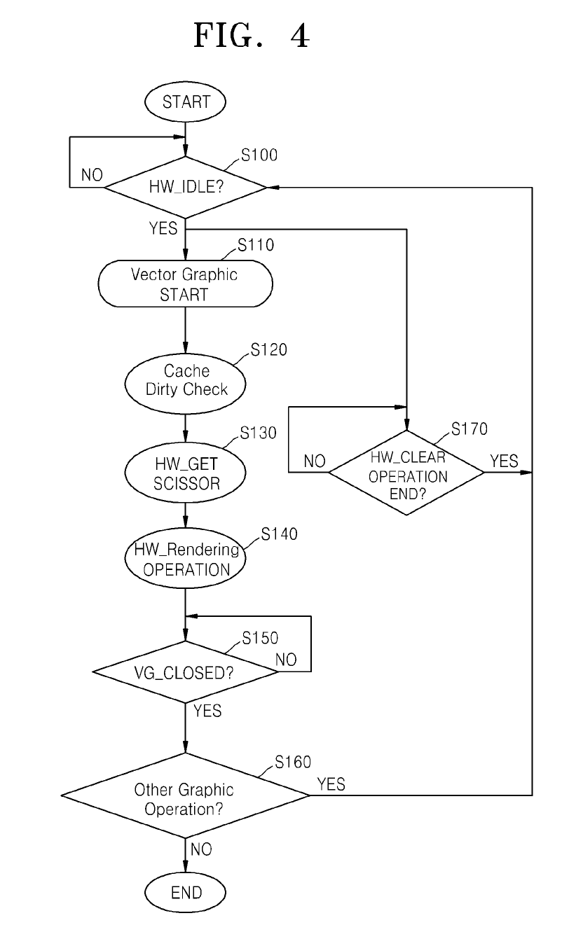

FIG. 4 is a flowchart illustrating a vector graphics accelerating method according to an embodiment of the present disclosure. In other words, FIG. 4 illustrates the overall finite state machine (FSM) for a hardware type vector graphics accelerator. For hardware control and operation, the FSM allows a command core and parser to timely read commands and data from multiple registers to improve the speed of graphics processing of the vector graphics accelerator.

Referring to FIG. 4, an arm core determines whether a hardware type processor is in an idle state (S100). That is, in operation S100, it is determined whether the hardware type processor is in the operational state or is in the idle state. Here, the hardware type processor indicates an application processor that includes the above hardware type vector graphics accelerator.

When the ARM core determines in S100 that the hardware type vector graphics processor is in the idle state, the arm core initializes the vector graphics accelerator (S110).

The ARM core (for example, the software device driver in the ARM core) performs a check on the caches used in graphics processing (S120). In checking the caches, the ARM core determines whether a command that has already been processed is to be processed again. The caches are checked before running the vector graphic processor to quickly and directly process a command, which is repeatedly given from among already processed commands, based on the cache data and without having to process the repeated command by using the vector graphics accelerator. This prevents unnecessarily processing commands that need not be processed by the vector graphics accelerator.

The vector graphics accelerator performs scissor processing to scissor unnecessary portions of graphics while maintaining the necessary or desired portions of graphics (S130). That is, data for scissor processing is read according to the state of the graphics, and then, the unnecessary or undesired portions of graphics are scissored.

The vector graphics accelerator performs actual graphics processing, i.e., a rendering operation (S140). As described above in detail with reference to FIGS. 1 to 3, in operation S140, graphics processing is performed in a hardware manner at high speeds by connecting modules of the hardware type vector graphics accelerator to the command core and parser and the register set. Here, the rendering operation includes paint generation, alpha masking, and blending which are performed in order to generate 2D vector elements, except for a rasterizing setup and scissor processing.

The vector graphics accelerator closes or ends operation (S150). Closing the operation represents the vector graphics accelerator terminating a graphic operation in one frame. However, the vector graphics accelerator may not be shut down completely. Also, the closing operation is performed in the vector graphics accelerator (or acceleration application processor) not in the ARM Core. After the “closing” operation, the accelerator (or acceleration application processor) informs the ARM Core of the closing of accelerator. Whether to close the hardware type vector graphics accelerator is determined according to a graphic state mode of the registers. As illustrated in FIG. 4, when the vector graphics accelerator is closed, the hardware type vector graphics processor determines whether another graphics processing is needed to be performed (S160). When another graphics processing is needed to be performed, the method proceeds to S100, and when another graphics processing is not needed to be performed, the method is terminated.

After S100 is performed, the hardware type vector graphics processor performs a ‘clear’ operation to clear a frame buffer, separately from graphics processing (S170). The clear operation is performed during performing of graphics processing (i.e., in parallel), and is terminated when the performing of graphics processing ends.

Whether to terminate S100, S150 and S170 is determined by the hardware type vector graphics processor based on a register value of each of the frames at an accelerating engine level. When the hardware type vector graphics processor determines that S100, S150 and S170 are to be continued, they are continuously performed as long as the method operates. That is, as illustrated in FIG. 4, these operations are continuously performed according to a loop-back scheme.

In the above embodiments of a hardware type vector graphics accelerator, an application processor that include the hardware type vector graphics accelerator, and a graphics accelerating method performed by the application processor, vector graphics are processed in a hardware manner rather than a conventional software rendering manner. Accordingly, it is possible to process high-quality vector contents at high speeds by supporting an accelerator included in an application processor for use in a mobile communication terminal to overcome the problems of the conventional software rendering manner.

Rendering parts (accelerator) of vector graphics is designed in a hardware manner, and controlling parts of vector graphics in a software manner is designed to have an API according to the OpenVG pipeline architecture of the Khronos group which is considered as the international standards. Also, a vector graphics accelerator is designed to be interfaced with a duration of graphics accelerating of the OpenVG in the hardware manner. Therefore the vector graphics accelerator according to an embodiment of the present disclosure enables various vector contents to be used according to the OpenVG API standards.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

What is claimed is:

1. A hardware-type vector graphics accelerator, comprising:
graphics processing modules to communicate with a controller unit, the graphics processing modules include at least one of a rasterizing setup module, a scissor module, a paint generation module, an alpha masking module, or a blending module connected according to a pipeline architecture to perform two-dimensional (2D) vector graphics acceleration in response to one or more commands received from the controller unit.

2. The accelerator of claim 1, wherein the controller unit comprises a command core and parser unit to process and parse vector graphics data and the one or more commands used to instruct the graphics processing modules to perform the 2D vector graphics acceleration, and
wherein the command core and parser unit is configured to communicate with a register set that comprises multiple registers to store the one or more commands.

3. The accelerator of claim 2, wherein the controller unit comprises:
a cache memory comprising dedicated caches, each dedicated cache to communicate with a corresponding one of the paint generation module, the alpha masking module, and the blending module respectively;
a cache controller to communicate with the cache memory to control each dedicated cache in response to one or more commands from a cache core;
the cache core to communicate with the cache controller to process the one or more commands to instruct the cache controller to control the caches;
a buffer controller to communicate with the cache core to control a pixel buffer in response to at least another command received from the cache core; and
the pixel buffer to communicate with the buffer controller to store final pixel data under the control of the buffer controller.

4. The accelerator of claim 1, wherein the graphics processing modules are configured to process contents based on open vector graphics accelerator (OpenVG) application programming interface (API) standards of Khronos group.

5. The accelerator of claim 4, comprising an application programming interface (API) adapted to be compliant with an OpenVG pipeline architecture, and the accelerator is interfaced with a duration of graphics accelerating of the open vector graphics accelerator (OpenVG).

6. A vector graphic acceleration application processor comprising:
a register set comprising multiple registers to store one or more commands adapted for vector graphics acceleration of vector graphics data;
a controller unit to communicate with the register set, the controller unit comprising at least a command core and parser unit to process and parse the one or more stored commands and the vector graphics data; and
a hardware-type vector graphics accelerator to communicate with the controller unit to process vector graphics acceleration on the vector graphics data in a hardware manner in response to receiving at least one of the parsed and processed commands from the command core and parser unit.

7. The vector graphic acceleration application processor of claim 6, wherein the hardware-type vector graphics accelerator comprises graphics processing modules that include at least one of a rasterizing setup module, a scissor module, a paint generation module, an alpha masking module, and a blending module connected together according to a pipeline architecture,
wherein the graphics processing modules are configured to operate in response to the received at least one parsed and processed command from the command core and parser unit.

8. The vector graphic acceleration application processor of claim 7, further comprising:
a cache memory comprising dedicated caches, each dedicated cache to communicate with a corresponding one of the paint generation module, the alpha masking module, and the blending module respectively;
a cache controller to communicate with the cache memory to control each dedicated cache in response to one or more commands from a cache core;
the cache core to communicate with the cache controller to process the one or more commands to instruct the cache controller to control the caches;
a buffer controller to communicate with the cache core to control a pixel buffer in response to at least another command received from the cache core; and
the pixel buffer to communicate with the buffer controller to store final pixel data under the control of the buffer controller.

9. The vector graphic acceleration application processor of claim 8, wherein the command core and parser unit and the cache core are connected to an arm core using an advanced high-performance bus (AHB) slave and an AHS master respectively.

10. The vector graphic acceleration application processor of claim 7, wherein, to process the vector graphics data, the vector graphics accelerator comprises:
a path generation module to generate path segment commands according to each of processing units in the paint generation module, based on values stored in the register set, wherein
the path segment commands comprise:
commands for straight lines,
commands for Bezier curves, and
commands for elliptical arcs; and
wherein the path generation module is configured to sort reconstructed straight lines based on a merge sorting algorithm to apply the reconstructed straight lines to a filling rule.

11. The vector graphic acceleration application processor of claim 7, wherein the processing units in the paint generation module comprise a solid unit for solid color processing, an image unit, a pattern unit, a linear gradient unit, and a radial gradient unit; and
the blending module comprises mode units comprising a blend mode unit and a blend image mode unit for blending processing;
wherein the processing units of the paint generation module and the mode units of the blending module respectively perform the color processing and the blending processing by using a color processing method and a blending processing method, based on open vector accelerator (OpenVG) application programming interface (API) standards of Khronos group.

12. A vector accelerating method comprising:
detecting a state of a vector graphics acceleration application processor;
when detecting that the vector graphics acceleration application processor is in an idle state, initializing a hardware-type vector graphics accelerator of the vector graphics acceleration application processor;
controlling the initialized hardware-type vector graphics accelerator to accelerate vector graphics data; and
closing the vector graphics accelerator.

13. The method of claim 12, wherein accelerating the vector graphics data comprises:
checking caches used in the vector graphics accelerating to determine whether to reprocess a command that has already been processed;
scissoring the vector graphics data to scissor-out undesired graphics elements; and
rendering the scissored vector graphics data to perform color processing.

14. The method of claim 13, wherein detecting the state of the vector graphics acceleration application processor, scissoring, and closing of the vector graphics accelerator are performed according to a loop-back scheme and based on a register value of each frame of the vector graphics data.

15. The method of claim 12, further comprising clearing a frame buffer after detecting the state of the vector graphics acceleration application processor.

16. The method of claim 12, wherein accelerating of the vector graphics data is performed by the initialized hardware-type vector graphics accelerator in response to one or more commands from a command core and parser unit included in the vector graphics acceleration application processor.

17. The method of claim 16, wherein accelerating of the vector graphics data is performed by a rasterizing setup module, a scissor module, a paint generation module, an alpha masking module, and a blending module which are connected to the command core and parser unit, wherein the rasterizing setup module, the scissor module, the paint generation module, the alpha masking module, and the blending module are connected together according to a pipeline architecture in the vector graphics accelerator.

18. The method of claim 17, wherein the paint generation module, the alpha masking module, and the blending module are respectively connected to corresponding caches;
processing and parsing, at the command core and parser unit, the vector graphics data and the one or more commands adapted to perform the vector graphics acceleration;
storing final pixel data in a pixel buffer;
processing, at the cache core, commands for operating the caches and the pixel buffer; and
controlling, at a cache controller and a buffer controller, the caches and the pixel buffer respectively in response to the commands from the cache core.

19. The method of claim 17, wherein controlling the initialized hardware-type vector graphics accelerator to accelerate the vector graphics data comprises:
generating, at a path generation module, path segment commands according to each processing unit in the paint generation module, based on values stored in a register set that stores the one or more commands adapted for vector graphics acceleration; and
sorting reconstructed straight lines based on a merge sorting algorithm to apply the reconstructed straight lines to a filling rule.

20. The method of claim 17, wherein color processing is performed by a solid unit, an image unit, a pattern unit, a linear gradient unit, and a radial gradient unit which are included in the paint generation module;
blending processing is performed using a blend mode unit and a blend image mode unit included in the blending module; and
performing color processing and blending processing, at the processing units of the paint generation module and the mode units of the blending module respectively, by using a color processing method and a blending processing method based on open vector accelerator (OpenVG) application programming interface (API) standards of Khronos group.
